(19) United States
(12) Patent Application Publication
(10) Pub. No.: US 2025/0239169 A1
(43) Pub. Date: Jul. 24, 2025

(54) EXPLAINABLE ENGINEERING EDUCATION METAVERSE TO SUPPORT 3D MATRIX CURRICULUM

(71) Applicant: Korea University of Technology and Education Industry-University Cooperation Foundation, Cheonan-si (KR)

(72) Inventors: Won Tae KIM, Cheonan-si (KR); Seong Jin YUN, Cheongju-si (KR); Jin Woo KWON, Cheonan-si (KR)

(21) Appl. No.: 18/427,410

(22) Filed: Jan. 30, 2024

(30) Foreign Application Priority Data
Jan. 23, 2024 (KR) 10-2024-0010235

(51) Int. Cl. G09B 5/06

(52) U.S. Cl. CPC G09B 5/065

(57) ABSTRACT

A method of providing education may be provided. The method of providing education may include: constructing a matrix-type curriculum database consisting of subject information corresponding to each curriculum for each technology; obtaining a language model corresponding to a student based on learning data of the student, and spawning a virtual NPC that provides an education service to the student in a metaverse space based on the language model; determining curriculum corresponding to the student based on the learning data; determining content corresponding to the student based on the curriculum and the learning data; and evaluating an achievement level of the student based on the learning data.

### CROSS-REFERENCE TO RELATED APPLICATIONS

This application claims the priority of the Korean Patent Applications NO 10-2024-0010235, filed on Jan. 23, 2024, in the Korean Intellectual Property Office. The entire disclosures of all these applications are hereby incorporated by reference.

### BACKGROUND

### 1. Field

One or more embodiments relate to a matrix-type curriculum system that enables learner-centered, flexible engineering education, and a method of providing engineering education using IT technology as an engineering education metaverse that utilizes explainable artificial intelligence technology to effectively support matrix-type curriculum with a learner-centered approach.

### 2. Description of the Related Art

In the future engineering education environment that requires multidisciplinary knowledge such as self-driving cars, industrial autonomous robots, and ultra-high-efficiency batteries, a flexible and dynamic education system beyond traditional department-centered education is needed. In the future engineering technology market that requires multidisciplinary knowledge centered on AI technology, a greater number of instructors than before are required to ensure that this education system operates smoothly. However, the level of expertise required for each instructor has also increased significantly, creating difficulties in the supply and demand of teachers. In addition to the supply and demand of teachers, space and cost issues related to the laboratory equipment required for each technology education are simultaneously occurring.

To solve these problems, many online learning platforms that utilize both metaverse technology and simulation technology have emerged, but there is a limitation that students need to find the content necessary to achieve their academic goals on their own. In addition, even if students find appropriate content and study on their own, there is still a limitation that it is difficult to overcome learning difficulties on their own because it is a one-sided education.

### SUMMARY

According to an aspect of an embodiment, a method of providing education includes: constructing a matrix-type curriculum database consisting of subject information corresponding to each curriculum for each technology; obtaining a language model corresponding to a student based on learning data of the student, and spawning a virtual NPC that provides an education service to the student in a metaverse space based on the language model; determining curriculum corresponding to the student based on the learning data; determining content corresponding to the student based on the curriculum and the learning data; and evaluating an achievement level of the student based on the learning data.

According to an aspect of an embodiment, the method of providing education further includes: adjusting the curriculum based on a change in status data of the student, wherein the change in status data may include at least one of a change in an academic progress of the student, a change in learning tendency, and a change in learning purpose.

According to an aspect of an embodiment, the method of providing education further includes: generating feedback on a model developed by the student.

The generating of feedback may include: searching for an improved model than the model developed by the student based on a genetic algorithm; comparing performance of the model developed by the student with performance of the improved model, and performing an evaluation of the model developed by the student; and generating feedback based on the improved model and a result of the evaluation.

The performing of an evaluation may include: generating a first heat map of the model developed by the student; generating a second heat map of the improved model; calculating an overlapping area between the first heat map and the second heat map; and performing the evaluation based on the overlapping area.

The constructing of a curriculum database may include: constructing a 3D matrix-type curriculum database by stacking matrices according to students' level.

The evaluating of an achievement level may include: inputting the model developed by the student into a simulation-based evaluation block; generating a heat map by inputting a recognition result output from the simulation-based evaluation block into an AI model analysis block; and extracting weak points of the model developed by the student based on environmental data of the simulation-based evaluation block, the heat map, and a prediction result of the model developed by the student.

### DETAILED DESCRIPTION

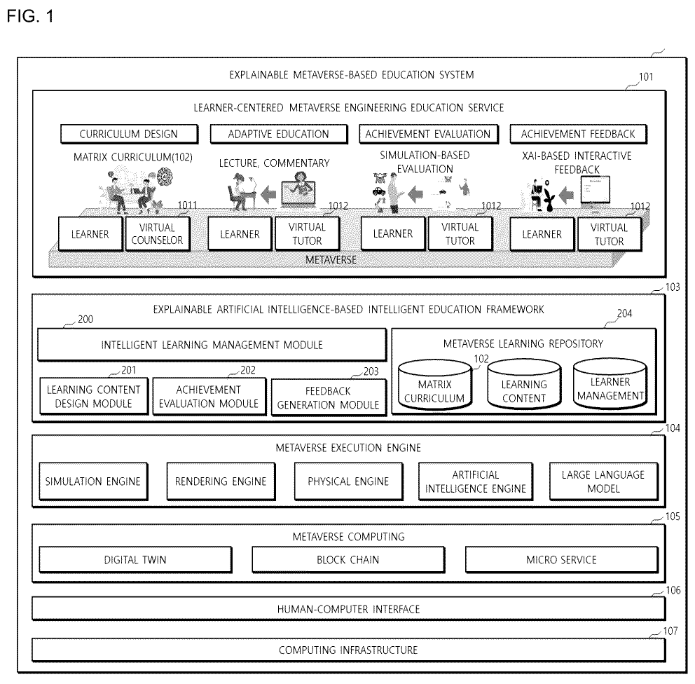

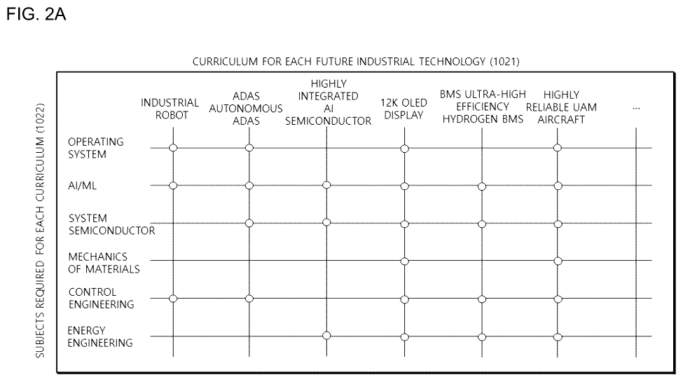

FIG. 1 is a view for explaining a structure of a metaverse-based education system according to an embodiment.

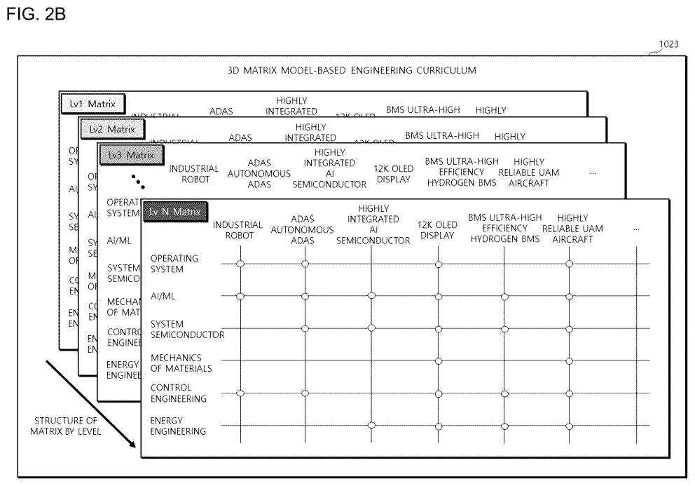

FIG. 2A and FIG. 2B are views of an example of a matrix curriculum according to an embodiment.

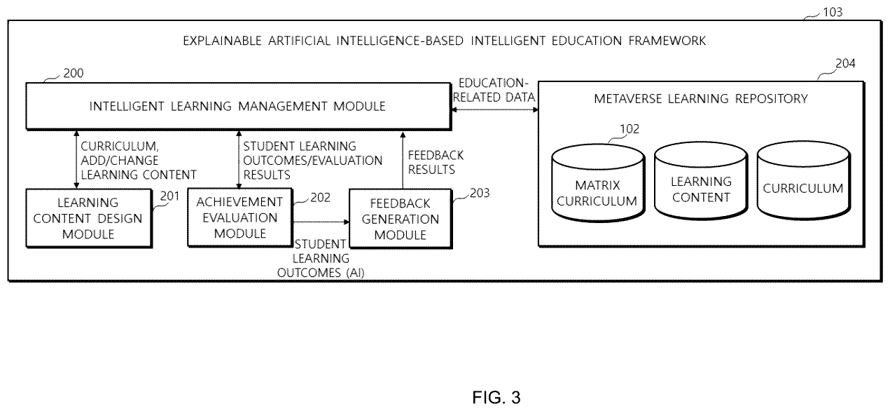

FIG. 3 is a configuration diagram of an explainable artificial intelligence-based intelligent education framework.

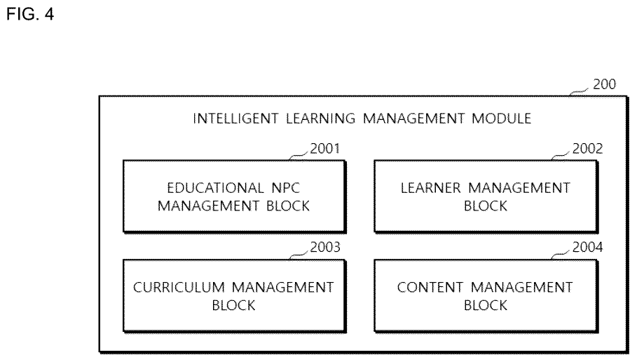

FIG. 4 is a configuration diagram of the intelligent learning management module 200 according to an embodiment.

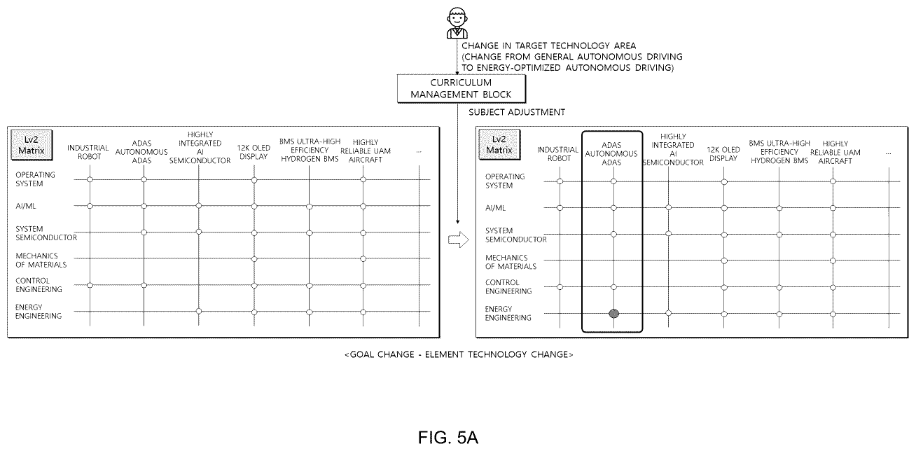

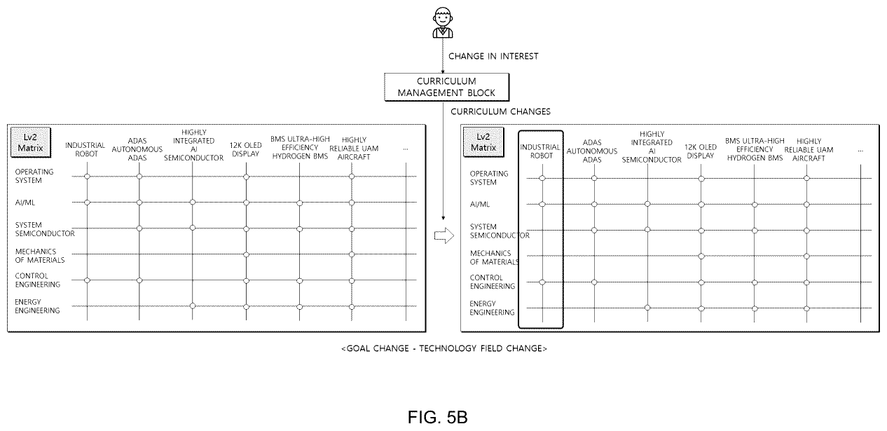

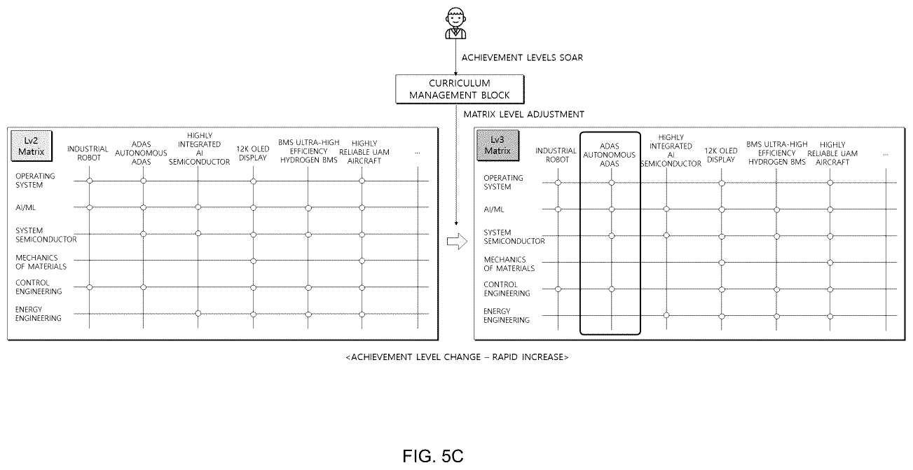

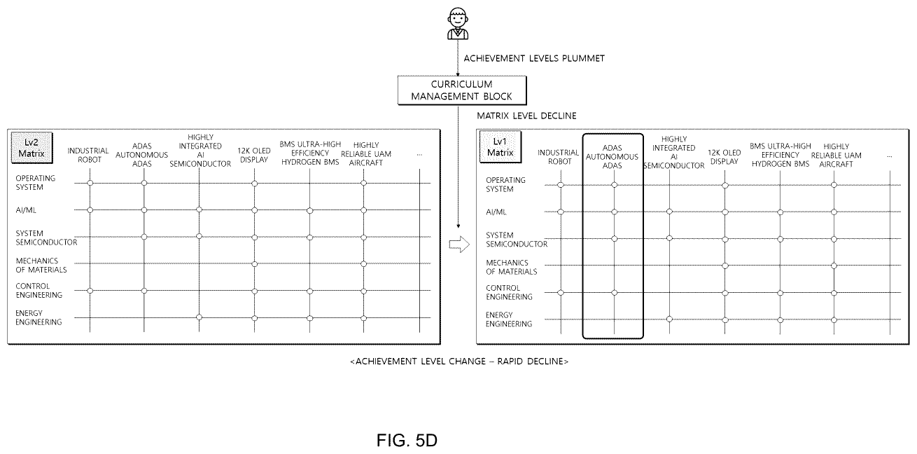

FIG. 5A, FIG. 5B, FIG. 5C and FIG. 5D are views of an example of adjusting curriculum according to an embodiment.

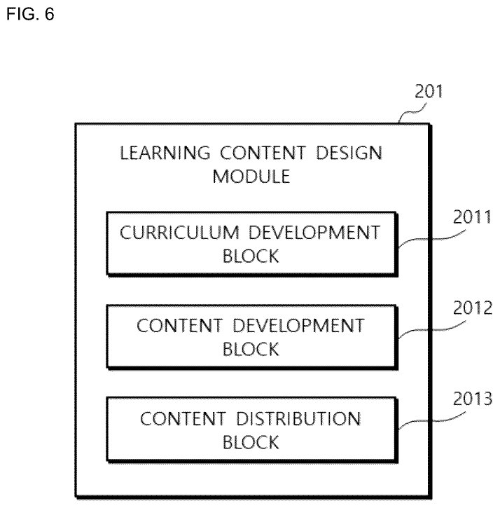

FIG. 6 is a configuration diagram of a learning content design module according to an embodiment.

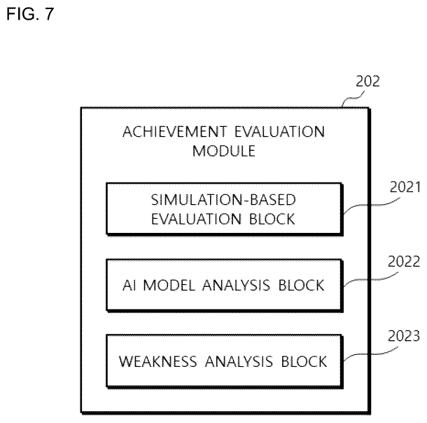

FIG. 7 is a configuration diagram of an achievement evaluation module according to an embodiment.

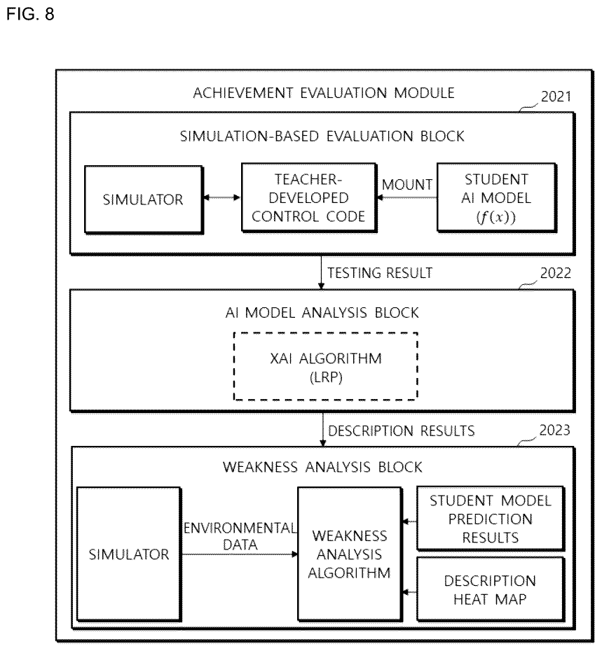

FIG. 8 is an example of implementation of an achievement evaluation module according to an embodiment.

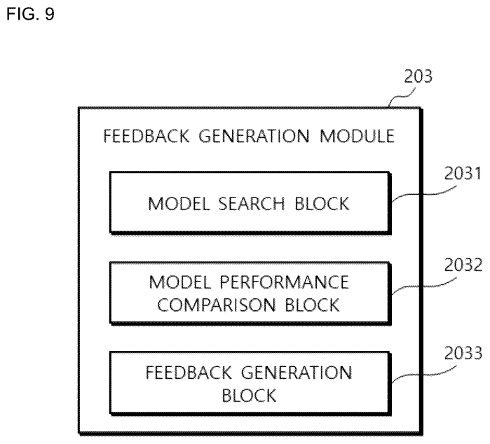

FIG. 9 is a configuration diagram of a feedback generation module according to an embodiment.

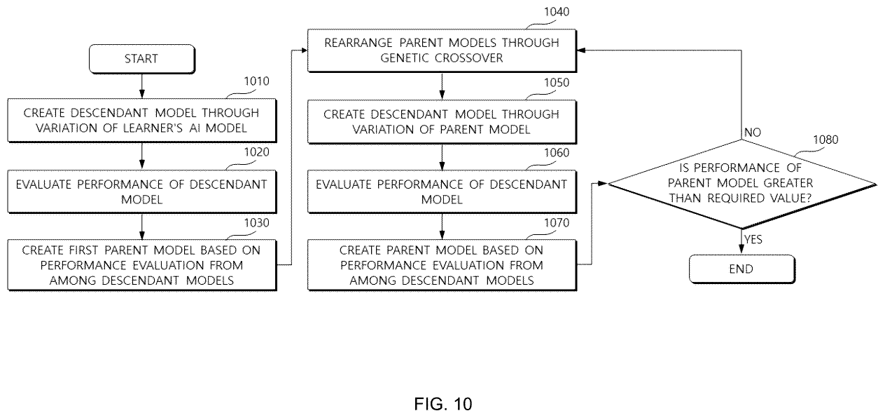

FIG. 10 is a flowchart for explaining operations of a genetic algorithm-based model search block, according to an embodiment.

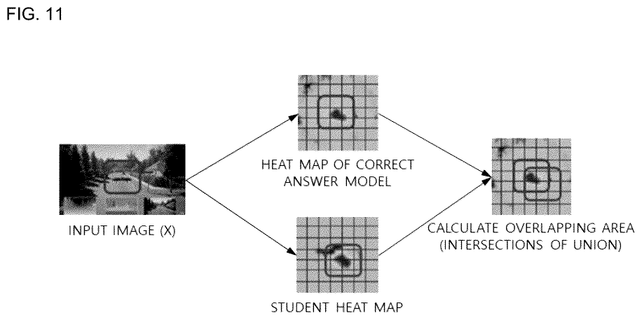

FIG. 11 is an example of a method of comparing model performance through heat map comparison, according to an embodiment.

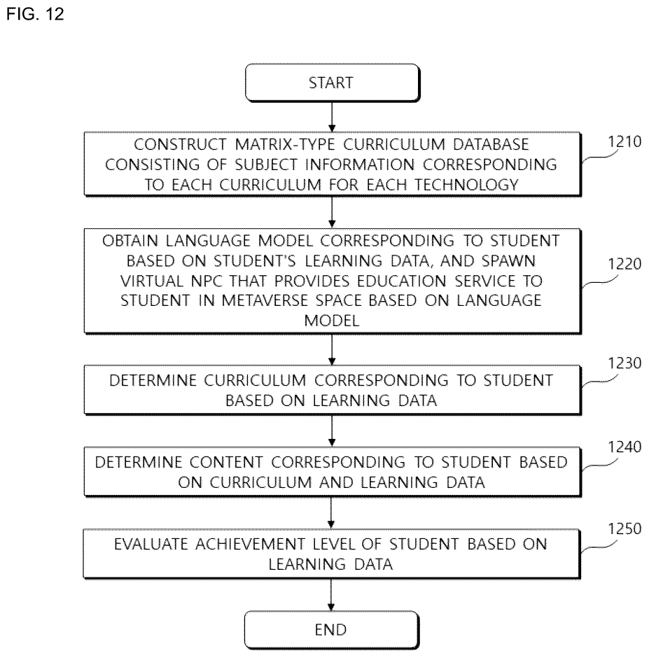

FIG. 12 is a flowchart for explaining a method of providing education according to an embodiment.

### DETAILED DESCRIPTION

Hereinafter, embodiments of the present invention will be described with reference to the drawings. In the following description, descriptions of a well-known technical configuration in relation to a lead implantation system for a deep brain stimulator will be omitted. For example, descriptions of the configuration/structure/method of a device or system commonly used in deep brain stimulation, such as the structure of an implantable pulse generator, a connection structure/method of the implantable pulse generator and a lead, and a process for transmitting and receiving electrical signals measured through the lead with an external device, will be omitted. Even if these descriptions are omitted, one of ordinary skill in the art will be able to easily understand the characteristic configuration of the present invention through the following description.

FIG. 1 is a view for explaining a structure of a metaverse-based education system according to an embodiment.

Referring to FIG. 1, a metaverse-based education system 100 according to an embodiment may be composed of six layers: a learner-centered metaverse engineering education service 101, an explainable artificial intelligence-based intelligent education framework 103, a metaverse execution engine 104, metaverse computing 105, a human-computer interface 106, and a computing infrastructure 107. Depending on the design of the metaverse-based education system 100, it is to be understood by one of ordinary skilled in the art that some of the configurations shown in FIG. 1 may be omitted or a new configuration may be added.

The metaverse-based education system 100 according to an embodiment may provide a matrix-type curriculum system that enables learner (hereinafter referred to as ‘student’)-centered, flexible engineering education, and an engineering education metaverse that utilizes explainable artificial intelligence technology to effectively support matrix-type curriculum with a learner-centered approach.

Through the metaverse-based education system 100 according to an embodiment, a student may receive learner-centered engineering education throughout the entire learning cycle regarding curriculum design and feedback on learning achievement, and a content developer may use services to develop educational content in a metaverse space.

The metaverse-based education system 100 according to an embodiment may provide a learner-centered metaverse engineering education service 101 to a student. The learner-centered metaverse engineering education service 101 may be provided in a metaverse space. To this end, the learner-centered metaverse engineering education service 101 may provide an educational metaverse NPC that operates using AI. A student may receive natural and customized learning design, education, and achievement feedback through a virtual counselor 1011 and a virtual tutor 1012, which are educational metaverse NPCs that operate using AI, even in a situation where there is no instructor connected in real time.

The virtual counselor 1011 according to an embodiment communicates with the student through a natural interface such as a large language model (LLM) to diagnose the student's goals (e.g., target technologies) and achievement levels, and uses functions of the explainable artificial intelligence-based intelligent education framework 103 to construct matrix curriculum 102 tailored to the student and returns it to the student. Operations of the explainable artificial intelligence-based intelligent education framework 103 and the matrix curriculum 102 are described in detail below with reference to FIGS. 2A to 3.

The virtual tutor 1012 according to an embodiment plays the role of a virtual teacher using a combination of large language models, simulation technology, and various forms of media (e.g., videos, books, 3D virtual environments, etc.) to provide educational content to students and provide evaluation and feedback on student achievement. A method of providing evaluation and feedback on student achievement is described in detail below with reference to FIGS. 7 to 11.

The metaverse-based education system 100 according to an embodiment may use the matrix curriculum 102 in providing a metaverse education service.

FIGS. 2A and 2B are views of an example of a matrix curriculum according to an embodiment.

Referring to FIG. 2A, the matrix curriculum 102 may be composed of curriculum for each future industrial technology 1021 requiring multidisciplinary knowledge as a first axis (e.g., an x-axis), and subjects required for each curriculum 1022 as a second axis (e.g., a y-axis). The curriculum for each future industrial technology 1021 may include, for example, industrial robot, autonomous ADAS, highly integrated AI semiconductor, 12 k OLED display, ultra-high efficiency hydrogen BMS, highly reliable UAM aircraft, etc. The subjects required for each curriculum 1022 may include, for example, operating system, AI/ML, system semiconductor, mechanics of materials, control engineering, energy engineering, etc. In a case of industrial robot technology, subjects in operating systems, AI/ML, and control engineering may be included. This type of curriculum composition centered on target technology facilitates the training of convergent talents who are experiencing limitations in existing departments or track systems. The matrix curriculum 102 according to an embodiment is not limited to the example shown in FIG. 2A and may be comprised of curriculums according to various types of industrial technologies.

Referring to FIG. 2B, by constructing a 3D matrix 1023 through stacking of matrices described in FIG. 2A, and constructing various levels and types of curriculums according to at least one of the industrial technology level, students' current achievement level, and students' achievement goals, it is possible to flexibly provide appropriate education tailored to the student's situation even if the technology is the same.

For example, the 3D matrix 1023 may be formed by stacking matrices according to students' level. A matrix corresponding to level i (i is a natural number between 1 and N) and a matrix corresponding to level j (j is a natural number between 1 and N different from i) may be composed of different curriculums even if they are the same industrial technology.

Referring again to FIG. 1, the explainable artificial intelligence-based intelligent education framework 103 may provide functions that support learner-centered engineering education through the metaverse. The explainable artificial intelligence-based intelligent education framework 103 according to an embodiment includes an intelligent learning management module 200 that supports learning management using artificial intelligence technology, a learning content design module 201 that supports development and distribution of curriculum and content that may be provided through a metaverse, an achievement evaluation module 202 that uses simulation technology and explainable artificial intelligence technology to evaluate student learning outcomes, a feedback generation module 203 that uses explainable artificial intelligence technology and a large-scale language model to provide optimized feedback to students, and a metaverse learning repository 204 that stores data generated or required in this process.

FIG. 3 is a configuration diagram of an explainable artificial intelligence-based intelligent education framework.

Referring to FIG. 3, the intelligent learning management module 200 provides student academic management functions such as educational NPCs and contents, and a learning content design module, an achievement evaluation module, and a feedback generation module work in conjunction with them to support learner-centered engineering education services.

The term “module” used in herein may mean, for example, a unit containing one or a combination of two or more of hardware, software, or firmware. The “module” may be used interchangeably with terms such as unit, logic, logical block, component, or circuit. The “module” may be the smallest unit of integrated parts or a part thereof. The “module” may be a minimum unit or part of one or more functions. The “module” may be implemented mechanically or electronically. For example, the “module” may include at least one of an application-specific integrated circuit (ASIC) chip, field-programmable gate arrays (FPGAs), or a programmable-logic device, known or to be developed in the future, that performs certain operations.

FIG. 4 is a configuration diagram of the intelligent learning management module 200 according to an embodiment.

Referring to FIG. 4, the intelligent learning management module 200 according to an embodiment may include management functions for curriculum, content, learners, and educational NPCs (e.g., the virtual counselor 1011 or the virtual tutor 1012) that provide education services in a metaverse space.

An educational NPC management block 2001 according to an embodiment may provide the ability to spawn and assign optimized NPCs to a student who spawns educational NPCs through fine-tuning functions of a large-scale language model. The educational NPC management block 2001 may provide obtain a language model corresponding to the student based on the student's learning data, and spawn a virtual NPC that provides an education service to the student in the metaverse space based on the language model. For example, the educational NPC management block 2001 may obtain a large-scale language model fine-tuned to suit the student through prompt engineering based on the student's learning data (e.g., online documents including the student's past grades, past papers, and recent papers on the student's main areas of interest), spawn a virtual object using this in the metaverse space, and spawn a customized educational NPC.

A learner management block 2002 according to an embodiment may manage a student's learning life cycle by calculating academic progress by performing a comprehensive and objective evaluation of the student's achievement level through an artificial intelligence model.

The learner management block 2002 may be implemented with functions of extracting student's weaknesses by analyzing student evaluation results using AI and comparing and analyzing them with past student cases with similar weaknesses to improve or adjust the student's curriculum in the same way that previous students achieved good academic results.

For example, the learner management block 2002 may extract student's weaknesses by inputting student's learning data into a pre-trained first artificial neural network model. The learner management block 2002 may input the extracted student's weaknesses into a second artificial neural network model to obtain a first list of past students with weaknesses similar to the student's weaknesses, and may obtain a second list composed of students who have overcome the weaknesses from the list. The learner management block 2002 may input the second list into a third artificial neural network model to determine optimal curriculum to overcome the weaknesses of the student being analyzed. For example, common curriculum of students included in the second list may be determined as the curriculum of the student being analyzed, or among the students included in the second list, the curriculum of the student with the highest degree of similarity to the student being analyzed may be determined as the curriculum of the student being analyzed. At this time, the first artificial neural network model, the second artificial neural network model, and the third artificial neural network model may be trained end-to-end at once, or may be trained separately.

A curriculum management block 2003 according to an embodiment creates curriculum through a matrix-type structure of subjects tailored to technical goals and allows the subjects of the curriculum to change according to changes in learner status data (e.g., changes in achievement and detailed goals, etc.), changes in social technology level, etc. The curriculum management block 2003 is implemented by artificial intelligence technology, and designs a 3D matrix divided into N detailed levels as presented in FIG. 2B using artificial intelligence technology that takes into account the level of technical goals and achievement levels that can be assigned to each student in various ways, so that optimized curriculum is provided.

FIGS. 5A to 5D are views of an example of adjusting curriculum according to an embodiment.

Referring to FIG. 5A, the curriculum management block 2003 according to an embodiment may adjust curriculum when a student's target technology area changes. For example, the curriculum management block 2003 may add “energy engineering” to the curriculum when the student's target technology area changes from “general autonomous driving” to “energy-optimized autonomous driving.”

Referring to FIG. 5B, the curriculum management block 2003 according to an embodiment may adjust the curriculum when student interests change. For example, the curriculum management block 2003 may adjust the curriculum from “autonomous vehicle ADAS” to “industrial robot” when student interests change.

Referring to FIGS. 5C and 5D, the curriculum management block 2003 according to an embodiment may adjust the curriculum when a student's achievement level changes. For example, referring to FIG. 5C, the curriculum management block 2003 may adjust the level of the curriculum from level 2 to level 3 when a student's achievement level increases. Alternatively, referring to FIG. 5D, the curriculum management block 2003 may adjust the level of the curriculum from level 2 to level 1 when a student's achievement level declines. An optimal level of the curriculum according to the student's achievement level may be determined in various ways. For example, the curriculum management block 2003 may determine a level corresponding to the student's achievement level by inputting the student's achievement level into a pre-trained artificial neural network.

Referring again to FIG. 4, a content management block 2004 includes general management functions such as indexing and content confirmation for learning content stored in the metaverse learning repository 204, and may provide a function to recommend content according to student conditions (e.g., learning propensity, achievement level, main purpose, etc.) based on artificial intelligence.

FIG. 6 is a configuration diagram of a learning content design module according to an embodiment.

Referring to FIG. 6, the learning content design module 201 according to an embodiment may develop matrix-type curriculum and provide functions for developing and distributing learning content corresponding to subjects included in the matrix-type curriculum. Through this, a content developer connected to a metaverse may develop curriculum and learning content.

A curriculum development block 2011 according to an embodiment uses online document search and artificial intelligence technology to analyze target technology, discover subjects required for the technology, and return them as a new matrix curriculum. An output result (e.g., curriculum draft) of this function block may be delivered to a user through the virtual tutor 1012.

The content development block 2012 according to an embodiment extracts detailed learning goals required for each subject based on artificial intelligence and presents recommended content to a content developer through the virtual tutor 1012 or various media to develop learning content.

A content distribution block 2013 according to an embodiment may provide a function that allows the developed learning content to be delivered to a student user accessing a metaverse space.

FIG. 7 is a configuration diagram of an achievement evaluation module according to an embodiment.

Referring to FIG. 7, the achievement evaluation module 202 according to an embodiment may use simulation technology and explainable artificial intelligence technology to evaluate work developed by a student according to engineering curriculum to provide the ability to quantify student's achievements and weaknesses.

A simulation-based evaluation block 2021 according to an embodiment utilizes various simulation functions provided by a metaverse execution engine, such as physics, dynamics, CFD, and discrete simulation, to perform tests on execution code and models developed by a student in the engineering curriculum through a metaverse.

An AI model analysis block 2022 according to an embodiment, when a student uses an artificial intelligence model, provides a function to in-depth analyze the performance of the model using explainable artificial intelligence technology. As an implementation example, a heat map of a CNN-based object recognition model may be obtained using a layer-wise relevance propagation (LRP) technique, and by comparing the heat map with correct answer object information, explanatory information about which parts an AI model performed object recognition based on may be obtained.

A weakness analysis block 2023 according to an embodiment may provide a diagnosis function for parts misrecognized by the AI model based on an analysis result of an explainable artificial intelligence model.

An achievement evaluation module 202 according to an embodiment may input a model developed by a student into the simulation-based evaluation block 2021, and may generate a heat map by inputting a recognition result output from the simulation-based evaluation block 2021 into the AI model analysis block 2022. The weakness analysis block 2023 may extract weak points of the model developed by the student based on environmental data of the simulation-based evaluation block, the heat map, and a prediction result of the model developed by the student.

FIG. 8 is an example of implementation of an achievement evaluation module according to an embodiment.

FIG. 8 shows a specific example of implementation of an achievement evaluation module for an object recognition model training case for an autonomous drone. Referring to FIG. 8, in the simulation-based evaluation block 2021 according to an embodiment, when a student develops an object recognition model and passes it to the simulation-based evaluation block, it is combined with drone control code that a teacher implemented during content development, allowing simulation-based evaluation to be performed while interacting with simulation.

A testing result (recognition result) is delivered to the AI model analysis block 2022, and the AI model analysis block 2022 may generate a heat map through an LRP algorithm. The weakness analysis module 2023 according to an embodiment needs to recognize simulator's environmental data, a heat map, and a student model prediction result by comparing them with each other, but weak points may be extracted through an algorithm that classifies parts that a student model does not recognize.

FIG. 9 is a configuration diagram of a feedback generation module according to an embodiment.

Referring to FIG. 9, the feedback generation module 203 according to an embodiment mainly focuses on an analysis function for a student's artificial intelligence model and may be composed of a model search block 2031, a model performance comparison block 2032, and a feedback generation block 2033.

The model search block 2031 according to an embodiment provides a neural architecture search function that searches for an artificial intelligence model architecture that further reaches a learning goal to explore improvements in a student's artificial intelligence model. As an example of implementation, an improved model may be found by manipulating the number of neural network layers and filter size of a CNN model through a genetic algorithm.

FIG. 10 is a flowchart for explaining operations of a genetic algorithm-based model search block, according to an embodiment.

Referring to FIG. 10, in operation 1010, the model search block 2031 may create descendant model through variation of a learner's (student's) AI model. In operation 1020, the model search block 2031 may evaluate the performance of the descendant model. In operation 1030, the model search block 2031 may create a first parent model based on performance evaluation from among descendant models. In operation 1040, the model search block 2031 may rearrange parent models through genetic crossover. In operation 1050, the model search block 2031 may create a descendant model through variation of a parent model. In operation 1060, the model search block 2031 may evaluate the performance of the descendant model, and in operation 1070, the model search block 2031 may create a parent model based on performance evaluation from among descendant models. In operation 1080, the model search block 2031 may determine whether the performance of the parent model is greater than a required value (e.g., a preset threshold), and when the performance is greater than the required value, the parent model may be determined as an improved model. On the other hand, when the performance is less than the required value, the model search block 2031 may return to operation 1040 and repeat the operation.

Referring again to FIG. 9, the model performance comparison block 2032 according to an embodiment may provide a function to compare the performance of the searched model and the performance of the student model to evaluate how much the performance has been improved and whether the performance has been sufficiently improved.

FIG. 11 is an example of a method of comparing model performance through heat map comparison, according to an embodiment.

Referring to FIG. 11, the model performance comparison block 2032 may compare overlapping areas to determine which of a CNN model before improvement and a CNN model after improvement output a heat map more similar to that of a correct answer model. In more detail, the model performance comparison block 2032 may generate a first heat map by inputting an input image into a model developed by a student, generate a second heat map by inputting the input image into an improved model, calculate an overlapping area between the first heat map and the second heat map, and perform evaluation based on the overlapping area.

Referring again to FIG. 9, the feedback generation block 2033 according to an embodiment may generate feedback in a form that humans can understand based on a search result and evaluation result and deliver the feedback to a user through a virtual tutor.

Referring again to FIG. 1, the metaverse execution engine 104 according to an embodiment may provide a computing library function necessary to implement and execute a metaverse. The metaverse execution engine 104 may include a simulation engine required to construct a high-precision virtual space such as dynamics and fluid dynamics, a rendering engine required for highly immersive virtual world expression, a physical engine necessary to implement physical laws in the real world, an artificial intelligence engine that provides artificial intelligence-related functions, and a large language model to support natural communication with people.

The metaverse computing 105 layer according to an embodiment is a layer that provides computing technologies necessary for smooth execution of the metaverse, and may include a digital twin that enables synchronization and convergence of the real and the virtual, a block chain that enables implementation of a distributed economic system, and a micro service computing function that enables flexible use of various functions.

The human-computer interface 106 is a layer that provides an interaction function between people (users) and the metaverse world, and may include VR HMD, XR haptics, AR glasses, etc.

The computing infrastructure 107 according to an embodiment is a base layer that provides computing resources necessary for metaverse implementation/development/management, and may include processing devices such as CPUs and GPUs, NPUs, and cloud computing infrastructure that manages them.

FIG. 12 is a flowchart for explaining a method of providing education according to an embodiment.

For convenience of explanation, operations 1210 to 1250 are described as being performed using the metaverse-based education system 100 shown in FIG. 1. However, these operations 1210 to 1250 may be used via any other suitable electronic device and within any suitable system.

In addition, operations of FIG. 12 may be performed in the illustrated order and manner, but the order of some operations may be changed or some operations may be omitted without departing from the spirit and scope of the illustrated embodiment. A number of operations shown in FIG. 12 may be performed in parallel or concurrently.

Referring to FIG. 12, in operation 1210, the metaverse-based education system 100 according to an embodiment may construct a matrix-type curriculum database consisting of subject information corresponding to each curriculum for each technology. The metaverse-based education system 100 according to an embodiment may construct a 3D matrix-type curriculum database by stacking matrices according to students' level.

In operation 1220, the metaverse-based education system 100 according to an embodiment may obtain a language model corresponding to a student based on the student's learning data, and spawn a virtual NPC that provides an education service to the student in a metaverse space based on the language model.

In operation 1230, the metaverse-based education system 100 according to an embodiment may determine curriculum corresponding to the student based on the learning data.

In operation 1240, the metaverse-based education system 100 according to an embodiment may determine content corresponding to the student based on the curriculum and learning data.

In operation 1250, the metaverse-based education system 100 according to an embodiment may evaluate an achievement level of the student based on the learning data.

The metaverse-based education system 100 according to an embodiment may adjust the curriculum based on a change in status data of the student, and the change in the status data may include at least one of a change in the student's academic progress, a change in learning tendency, and a change in learning purpose.

The metaverse-based education system 100 according to an embodiment may generate feedback on a model developed by the student. The metaverse-based education system 100 searches for an improved model than the model developed by the student based on a genetic algorithm, compares performance of the model developed by the student with performance of the improved model, performs an evaluation of the model developed by the student, and generate feedback based on the improved model and a result of the evaluation.

The embodiments described above may be implemented by hardware components, software components, and/or any combination thereof. For example, the devices, the methods, and components described in the embodiments may be implemented by using general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other devices which may execute and respond to instructions. A processing apparatus may execute an operating system (OS) and a software application executed in the OS. Also, the processing apparatus may access, store, operate, process, and generate data in response to the execution of software. For convenience of understanding, it may be described that one processing apparatus is used.

However, one of ordinary skill in the art will understand that the processing apparatus may include a plurality of processing elements and/or various types of processing elements. For example, the processing apparatus may include a plurality of processors or a processor and a controller. Also, other processing configurations, such as a parallel processor, are also possible.

The software may include computer programs, code, instructions, or any combination thereof, and may construct the processing apparatus for desired operations or may independently or collectively command the processing apparatus. In order to be interpreted by the processing apparatus or to provide commands or data to the processing apparatus, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and/or data may be recorded in a computer-readable recording medium.

A method according to an embodiment may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier.

In concluding the detailed description, those skilled in the art will appreciate that many variations and modifications may be made to the preferred embodiments without substantially departing from the principles of the present invention. Therefore, the disclosed preferred embodiments of the invention are used in a generic and descriptive sense only and not for purposes of limitation.

1. A method of providing improved education using a metaverse-based AI education system, the method comprising:
constructing a 3D matrix-type curriculum database stored in a non-transitory memory, wherein the 3D matrix-type curriculum database consists of subject information corresponding to each curriculum for each technology;
obtaining a student-specific language model by fine-tuning a large-scale AI model using a student-specific learning data;
spawning a virtual NPC tutor in a metaverse environment, wherein the virtual NPC tutor provides an education service to a corresponding student based on the student-specific language model;
determining a curriculum using AI-driven reinforcement learning based on the student-specific learning data;
determining content optimized to the corresponding student based on the curriculum and the student-specific learning data;
evaluating an achievement level of the corresponding student based on the student-specific learning data,
wherein,
a student's AI model is tested in a metaverse-based simulation environment,
an AI heat map is generated to assess the student's AI model, and
weakness in the student's AI model is identified through AI-driven comparative analysis; and
generating personalized feedback by:
searching for an improved AI model using a genetic algorithm-based model search module,
comparing performance metrics between the student's AI model and the improved model, and
providing human-interpretable feedback via an AI-powered virtual tutor.

2. The method of claim 1, further comprising:
adjusting the curriculum based on a change in status data of the student using a deep learning-based curriculum optimization algorithm,
wherein the change in status data comprises at least one of a change in an academic progress of the student, a change in learning tendency, and a change in learning purpose.

3. (canceled)

4. (canceled)

5. The method of claim 14, wherein the evaluation step comprises:
generating a first heat map of the model developed by the corresponding student;
generating a second heat map of the improved model;
calculating an overlapping area between the first heat map and the second heat map; and
performing the evaluation based on the overlapping area.

6. The method of claim 1, wherein the constructing of the 3D matrix-type curriculum database comprises:
stacking matrices corresponding to different student levels, wherein each matrix corresponds to a distinct learning depth for a given technology.

7. The method of claim 1,
wherein the metaverse-based AI education system comprises:
a deep brain stimulator comprising an implantable pulse generator and a lead, wherein electric signals measured through the lead are transmitted to an external device.

8. The method of claim 1,
wherein the metaverse-based AI education system comprises:
a learner-centered metaverse engineering education service,
an explainable artificial intelligence-based intelligent education framework,
a metaverse execution engine,
a metaverse computing,
a human-computer interface, and
a computing infrastructure.
